(19) United States
(12) Patent Application Publication
(10) Pub. No.: US 2015/0356061 A1
(43) Pub. Date: Dec. 10, 2015

(54) SUMMARY VIEW SUGGESTION BASED ON USER INTERACTION PATTERN

(71) Applicant: Microsoft Corporation, Redmond, WA (US)

(72) Inventors: Benjamin E. Rampson, Woodinville, WA (US); Christopher J. Gross, Redmond, WA (US); Poornima Hanumara, Seattle, WA (US); Anupam Garg, Sammamish, WA (US)

(21) Appl. No.: 14/297,810

(22) Filed: Jun. 6, 2014

(51) Int. Cl. G06F 17/24; G06F 3/0484

(52) U.S. Cl. CPC G06F 17/241; G06F 3/04842; G06F 3/04845

(57) ABSTRACT

A user interaction input is detected, indicating that a user is interacting with structured data. The user interaction input is identified as a pattern for which a summary view is to be generated. The summary view of the structured data is generated, based upon the detected pattern, and is displayed to the user.

### BACKGROUND

Computer systems are currently in wide use. Some computer systems allow users to generate or view structured data. By way of example, users often use spreadsheet applications to generate and view large amounts of data. The data is displayed in a structured format in which it is arranged in rows and columns.

However, spreadsheets are not the only types of systems that display data in a structured format. For instance, electronic mail systems present data in mailboxes (such as inboxes, sent mail boxes, outboxes, etc.) that are in a structured format as well. The data items in the mailboxes, for instance, often have sender and recipient fields, subject matter fields, data fields, etc. Word processing applications also allow users to generate and view structured data. For instance, many word processors allow users to generate and view tables. Again, the tables often have rows and columns according to which the data is arranged. Further, some browsers allow users to view structured data. For instance, a browser may allow a user to view a credit card statement, a bank statement, or other items in which data is presented according to a structure. Further, many business systems allow users to view data in a wide variety of different types of structures, such as reports, forms, etc.

In reviewing these types of data structures, users may often wish to gain a better understanding of the data. For instance, it may be that a user wishes to have the data presented in a more condensed form. To do this, some systems provide mechanisms such as pivot tables, or they allow the user to write formulas to perform various types of aggregation. Users can invoke these experiences and mechanisms by navigating through a variety of user interfaces.

The discussion above is merely provided for general background information and is not intended to be used as an aid in determining the scope of the claimed subject matter.

### SUMMARY

A user interaction input is detected, indicating that a user is interacting with structured data. The user interaction input is identified as a pattern for which a summary view is to be generated. The summary view of the structured data is generated, based upon the detected pattern, and is displayed to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative structured data generation/presentation system.

FIG. 2 is a more detailed block diagram of one embodiment of a pattern detector.

FIGS. 3A and 3B show a flow diagram illustrating one embodiment of the operation of the system shown in FIG. 1 in identifying a user interaction pattern and displaying a summary view of structured data.

FIGS. 3C-3L show various examples of user interface displays.

FIG. 4 is a flow diagram illustrating one embodiment of the operation of the pattern detector shown in FIG. 2 in identifying a pattern for which a summary view is to be generated.

FIG. 5 is a block diagram showing one embodiment of a plurality of different types of commonality that can be used in identifying patterns.

FIGS. 6-9 show various embodiments of mobile devices.

FIG. 10 is a block diagram of one illustrative computing environment.

### DETAILED DESCRIPTION

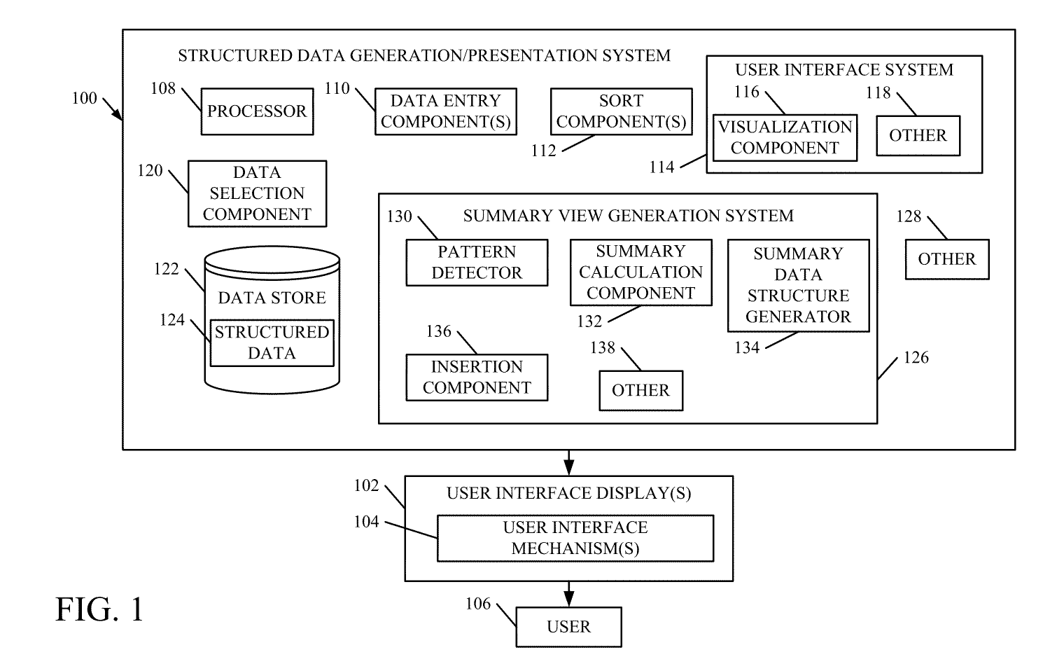

FIG. 1 is a block diagram of one example of a structured data generation/presentation system 100. System 100 illustratively generates user interface displays 102 with user input mechanisms 104 for interaction by user 106. User 106 illustratively interacts with user input mechanisms 104 in order to control and manipulate system 100.

System 100 illustratively either allows user 106 to generate structured data, or to at least view and interact with structured data. For instance, in one example, structured data generation/presentation system 100 is a spreadsheet system. In another example, it is a word processing system that allows user 106 to view or generate tables of data. System 100 can also, however, be a browser that allows user 106 to view and interact with structured data (such as bank statements, credit card statements, etc.). Similarly, system 100 can be a business system (such as an enterprise resource planning (ERP) system, a customer relations management (CRM) system, a line-of-business (LOB) system, or another system) that allows user 106 to review reports or other sets of structured data. System 100 can be an email system or a variety of other systems as well.

In the example shown in FIG. 1, structured generation/presentation system 100 will be described as a spreadsheet application that allows user 106 to generate, view and otherwise interact with structured data. However, it will be appreciated that this is only one example of such a system, and others can be used.

System 100 illustratively includes processor 108, data entry components 110, sort components 112, and user interface system 114 which, itself, includes visualization component 116 and it can include other components 118 as well. System 100 also includes data selection component 120, data store 122 which can store structured data 124, summary view generation system 126, and it can include other items 128 as well. Summary view generation view system 126 illustratively includes pattern detector 130, summary calculation component 132, summary data structure generator 134, insertion component 136, and it can include other items 138.

Before describing the operation of system 100 in more detail, a number of the items will be discussed, by way of overview. Data entry components 110 illustratively provide the functionality and components that allow user 106 to enter data into system 100. For instance, components 110 can be the interface mechanisms, functionality and components in a spreadsheet application that allow a user to enter data into the cells of a spreadsheet. Where system 100 is another type of system, components 110 correspond to that functionality in the other types of systems (where data entry can be performed). Sort components 112 provide the user interface mechanisms and functionality that allow user 106 to sort data within system 100. For instance, where user 106 is viewing structured data 124 (e.g., a spreadsheet), sort components 112 allow user 106 to sort the data in rows, columns or various other cells.

User interface system 114 illustratively generates (either by itself or under the control of other items in system 100) user interface displays 102. Visualization component 116 generates various visualizations that are presented on user interface displays 102. System 114 also detects user inputs through user input mechanisms 104 and provides an indication of that to other items in system 100.

Data selection component 120 illustratively provides the user interface mechanisms and functionality that allow user 106 to select data items in system 100. For instance, where structured data 124 is a spreadsheet, component 120 allows user 106 to select items of data (such as cells, rows, columns, etc.) in the spreadsheet.

Structured data 124 may have different forms depending on the particular type of system 100. Where system 100 is a spreadsheet application, then structured data 124 may be one or more different spreadsheets documents. Where system 100 is a word processing system, then structured data 124 may be one or more different tables or other items of structured data within one or more word processing documents. Where system 100 is a business system, then structured data 124 may be different forms or other structured data items within that system. Where system 100 is a browser, then structured data 124 may be a bank statement, a credit card statement or a wide variety of other structured data that can be viewed by the browser. Where system 100 is an electronic mail system, then structured data 124 may represent the user's inbox, sent items, etc.

It should also be noted that data store 122 is shown as being part of system 100, in FIG. 1. However, as will be described in greater detail below, it can be remote from system 100, and accessed by system 100. It can also be divided into multiple different data stores, some of which are local to system 100 and some of which are remote, or all of which are local or all of which are remote. All of these architectures are contemplated herein.

Summary view generation system 126 detects when user 106 is providing user interaction inputs that represent a pattern indicating that user 106 may wish to view a summary form of the structured data 124 that is currently being displayed to the user. Pattern detector 130 detects when the user interaction inputs identify such a pattern. Summary calculation component 132 calculates summary values for the structured data 124, once a pattern has been detected, and summary data structure generator 134 generates one or more different types of summary data structures that can be suggested to user 106 on user interface display 102. Insertion component 136 provides user input mechanisms and functionality that allow user 106 to easily insert any one of the summary data structures into the structured data 124, itself, or into another document containing structured data 124, so that it can be persisted along with the structured data 124, for later use.

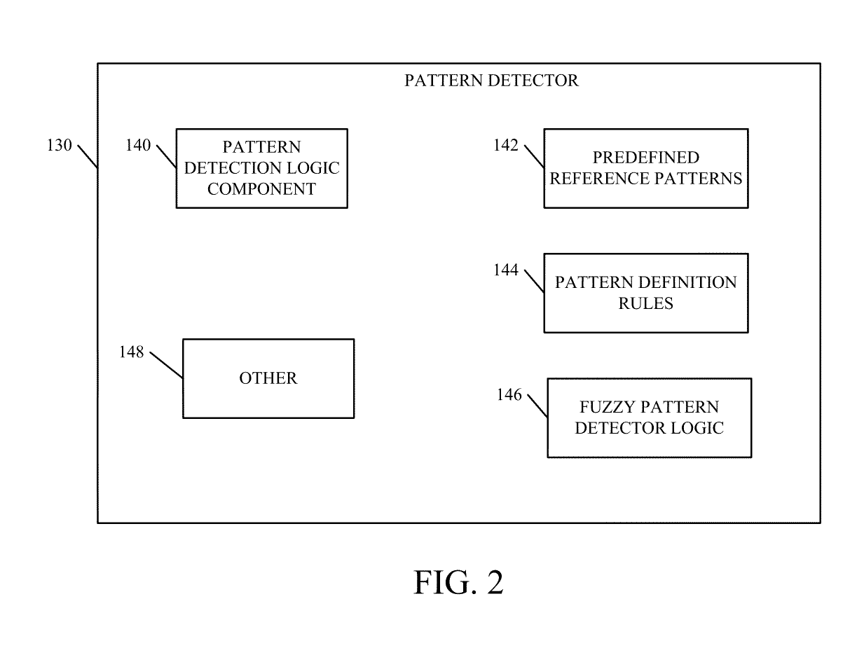

FIG. 2 is a block diagram illustrating one example of pattern detector 130 in more detail. FIG. 2 shows that pattern detector 130 can include pattern detection logic component 140, predefined reference patterns 142, pattern definition rules 144, fuzzy pattern detector logic 146, and it can include other items 148. In one example, pattern detection logic component 140 detects the user interaction inputs and accesses predefined reference patterns 142. Component 140 compares the user interaction inputs against a set of predefined reference patterns that indicate user interaction inputs that represent patterns for which a summary data view is to be generated. When the user interaction inputs match one of the predefined reference patterns 142, then pattern detector 130 detects a pattern.

In another example, instead of using predefined reference patterns 142 (or in addition thereto), pattern detector 130 includes pattern definition rules 144. Pattern detection logic component 140 applies the pattern definition rules 144 to the user interaction inputs that are detected from user 106. The pattern definition rules 144 include a set of rules that define when the user interaction inputs conform to a pattern for which a summary view is to be generated.

In yet another example, pattern detector 130 includes fuzzy pattern detector logic 146. This can be used instead of, or in addition to, predefined reference patterns 142 and/or pattern definition rules 144. In the example in which pattern detector 130 includes fuzzy pattern detector logic 146, pattern detection logic component 140 runs the fuzzy pattern detector logic as user interaction inputs are detected to determine whether the user interaction inputs conform to a pattern for which summary data is to be generated. It will be noted, of course, that instead of using patterns 142, rules 144 or fuzzy logic 146, pattern detector 130 can detect patterns in a wide variety of different ways, and those described herein are described for the sake of example only.

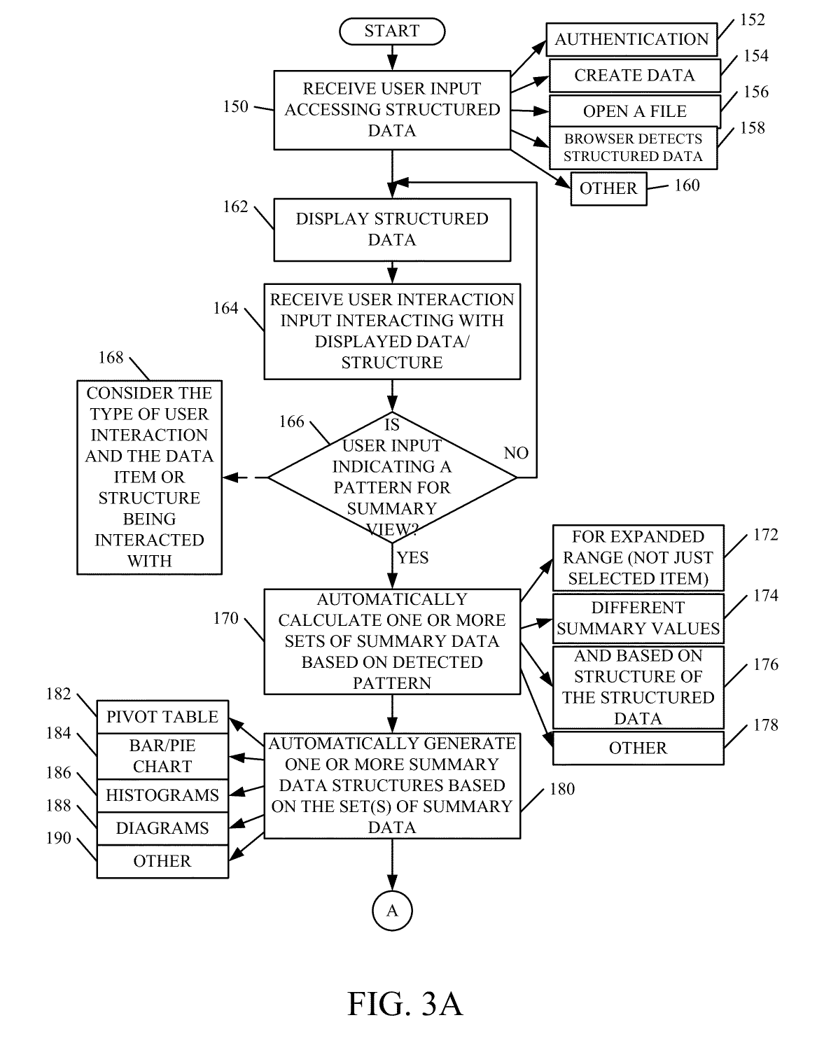

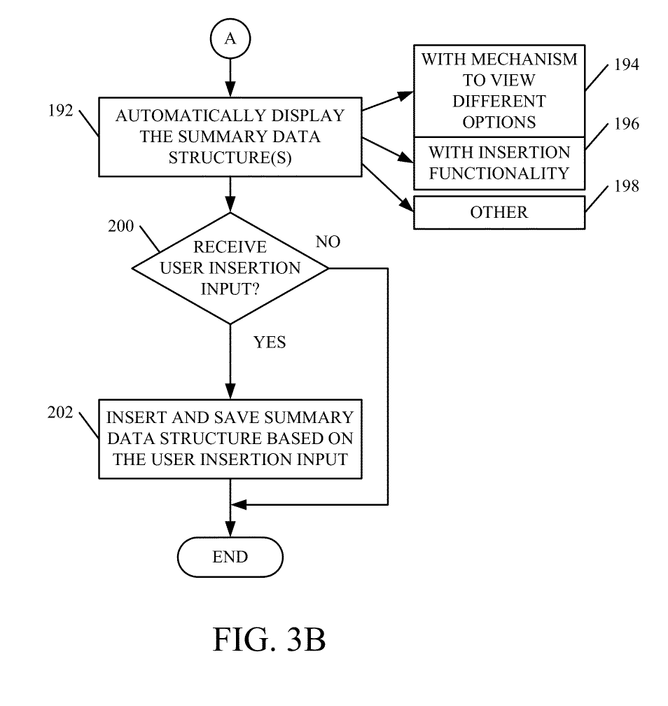

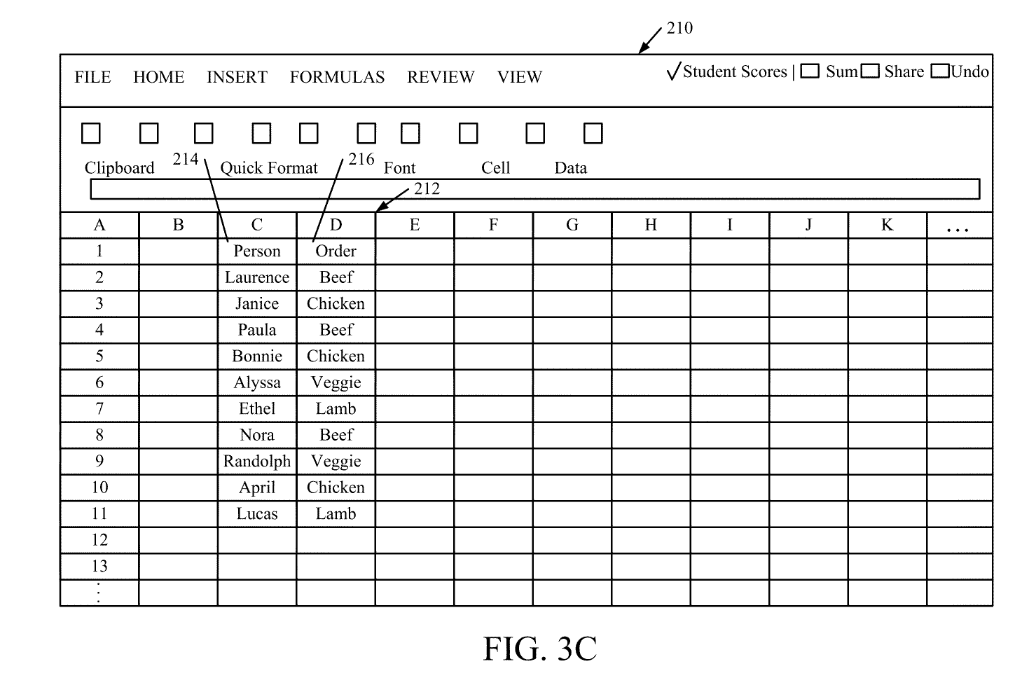

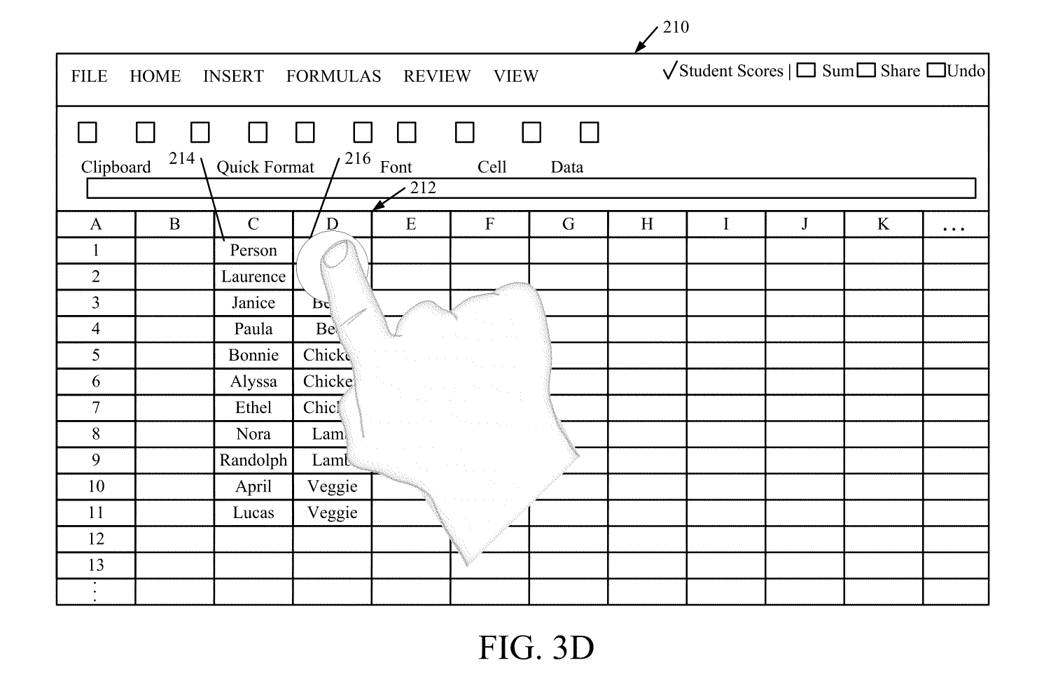

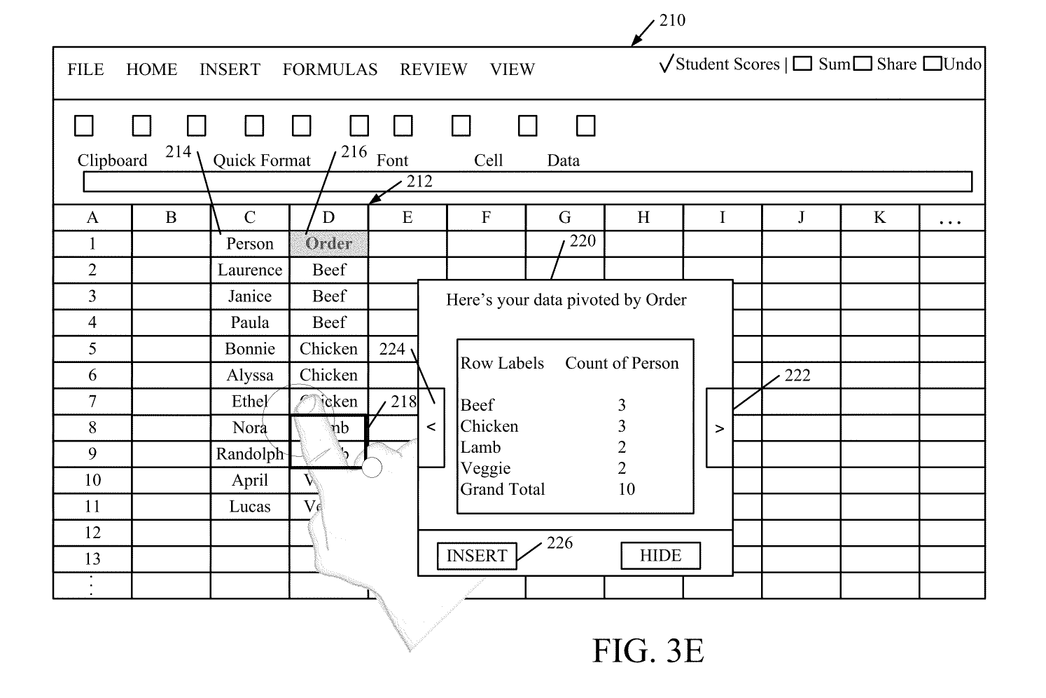

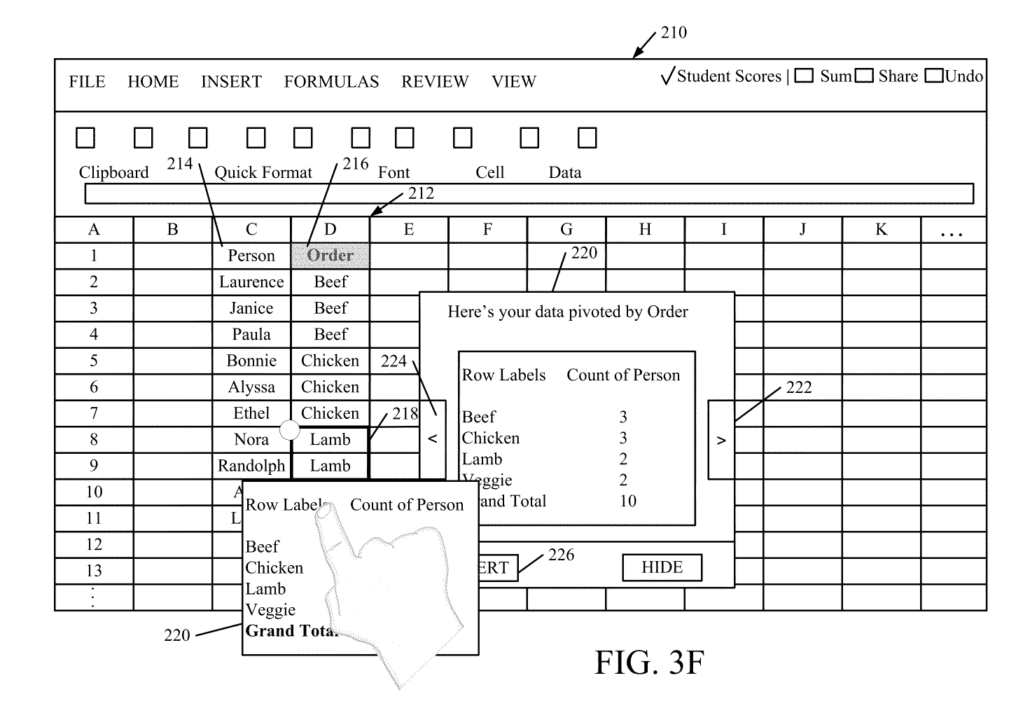

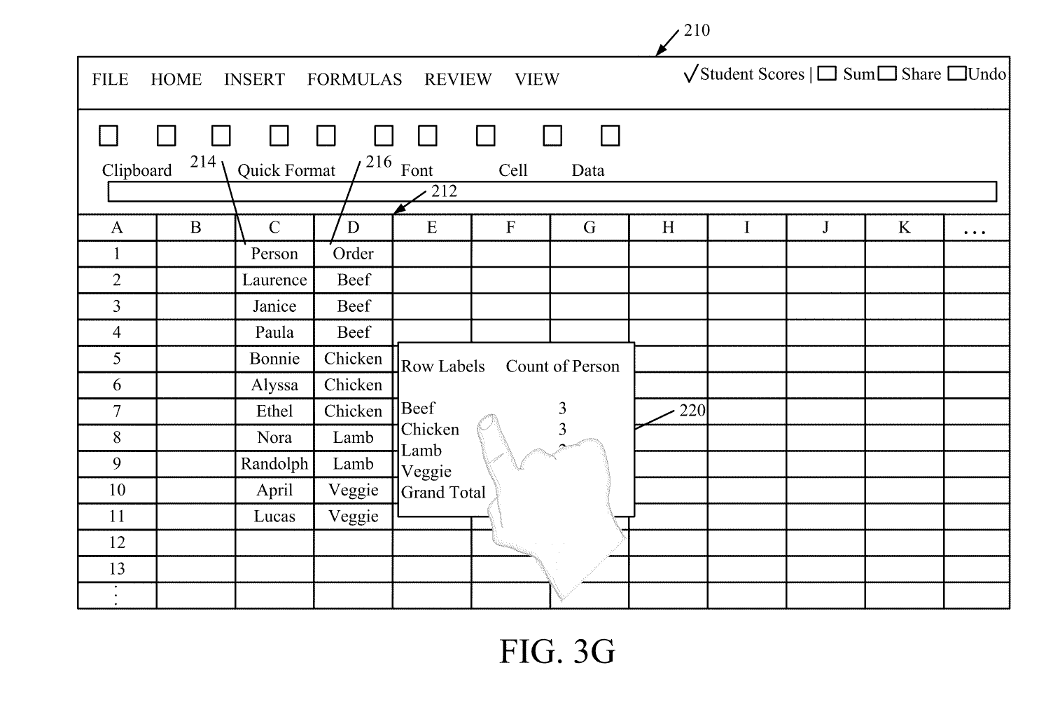

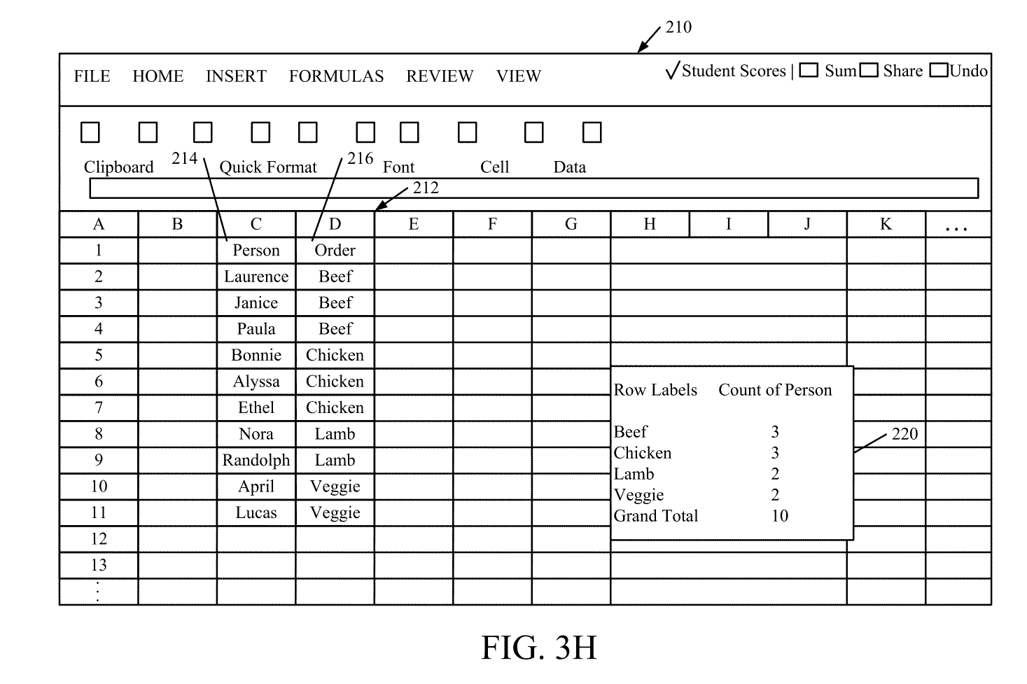

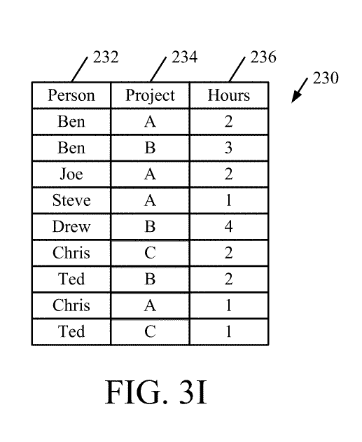

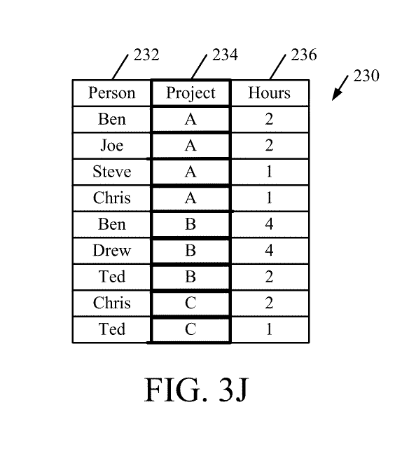

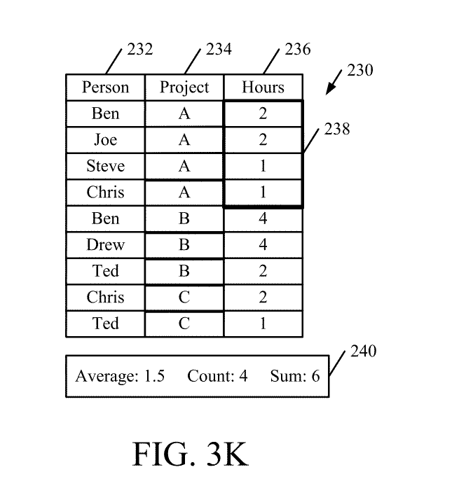

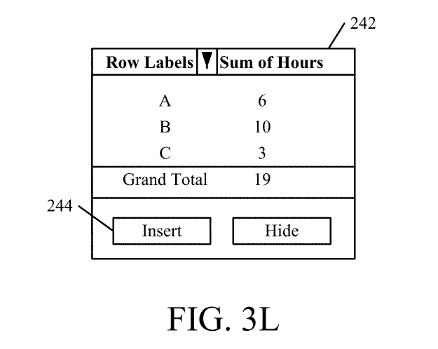

FIGS. 3A and 3B show a flow diagram illustrating one example of the operation of system 100 in detecting a user interaction pattern for which summary data is to be generated, and displaying a view of the summary data to the user. In one example, system 100 first receives a user input indicating that user 106 wishes to access structured data 124. This is indicated by block 150 in FIG. 3A. This can be done in a wide variety of different ways. For instance, user 106 can sign on to system 100 using authentication information 152. The user can initiate the creation of structured data 124, as indicated by block 154 in FIG. 3A. User 106 can also open a file where structured data 124 already exists. This is indicated by block 156. User 106 can open a browser (where system 100 is a browser) that detects that structured data is being accessed by the user. This is indicated by block 158. The user can also provide other inputs 160 indicating that he or she wishes to access structured data 124.

User interface system 114 then displays the structured data 124 that is being accessed by user 106. This is indicated by block 162 in FIG. 3A. For instance, where user 106 is accessing a spreadsheet in system 100, that particular spreadsheet is displayed to user 106 as structured data 124.

System 100 then receives one or more user interaction inputs interacting with the displayed data or with the structure through which the data is being displayed. This is indicated by block 164 in FIG. 3A. For instance, where the structured data 124 is a spreadsheet, the user may be interacting with the data structure (e.g., the spreadsheet) by sorting data within the spreadsheet. The user may be interacting with individual data items, themselves, such as by selecting individual cells, rows, columns, etc.

Pattern detector 130 then detects whether the user interaction inputs indicate a pattern for which a summary view of the displayed, structured data is to be generated. This is indicated by block 166. If not, then processing reverts to block 162 where system 100 continues to display the structured data and receive user interaction inputs. This may be the case, for instance, where the user is entering information using data entry components 110. This may also be the case where the user is simply viewing data, paging through data, etc.

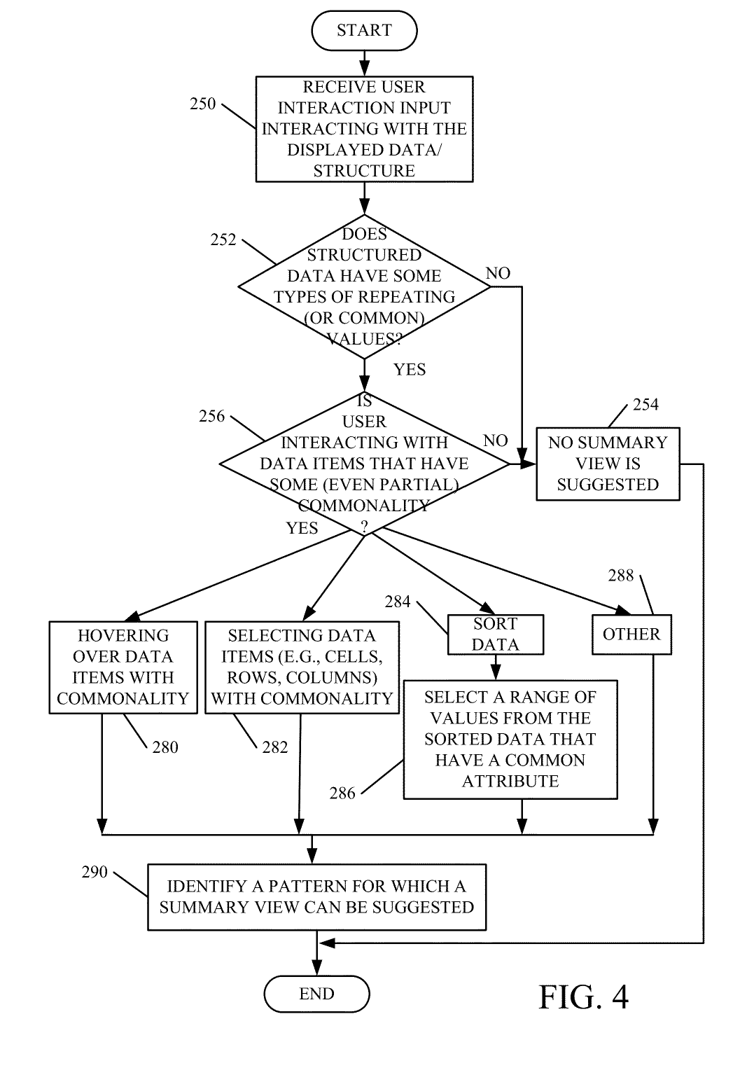

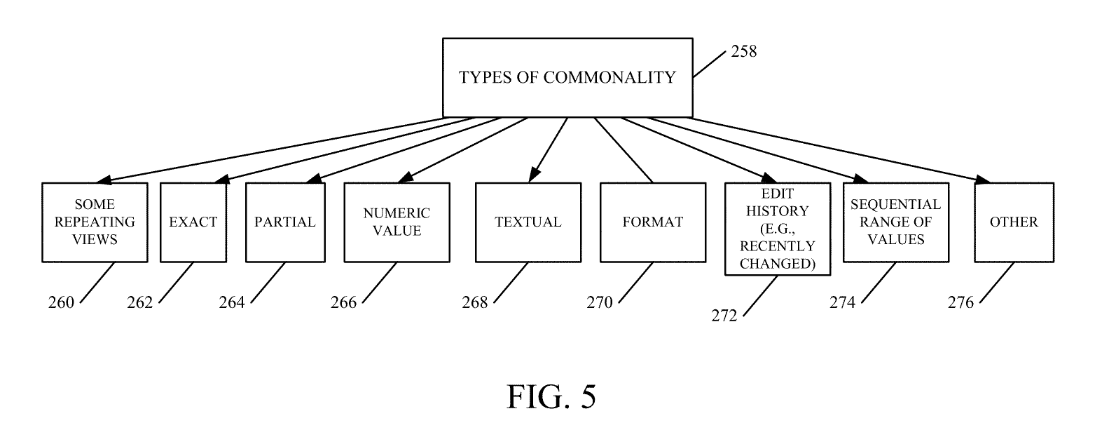

In making the determination as to whether a pattern is indicated, pattern detector 130 illustratively considers the type of user interaction input and the data item or structure being interacted with. This is indicated by block 168, and this is discussed in greater detail below with respect to FIGS. 4 and 5.

Where pattern detector 130 does identify that the user interaction input is indicating a pattern for which summary data is to be displayed, then summary calculation component 130 automatically calculates one or more sets of summary data based upon the detected pattern. This is indicated by block 170 in FIG. 3A. In one example, summary calculation component 132 not only calculates a summary of the data that user 106 is actually interacting with, but it calculates summary data for an expanded range of data. This is indicated by block 172. It can also calculate a variety of different types of summary values. This is indicated by block 174. For instance, when the data that user 106 is interacting with is numeric data, it may calculate a count, an average, a sum, or a variety of other types of summary data, some of which are described in more detail below.

Summary calculation component 132 can also calculate the summary data based upon the structure through which the structured data is being presented. This is indicated by block 176. By way of example, if the structured data is numeric data and it has an “average” total somewhere indicated in the structured data, then summary calculation component 132 can calculate the average value of the expanded range of data, as the summary data. It can also calculate a different summary view of the data that corresponds to the sum or count or other items. Summary calculation component 132 can calculate summary data in other ways as well, and this is indicated by block 178.

Summary data structure generator 134 then automatically generates one or more summary data structures based upon the set or sets of summary data calculated by summary calculation component 132. This is indicated by block 180 in FIG. 3A. By way of example, summary data structure generator 134 may generate a pivot table, inserting the summary data generated by summary calculation component 132. This is indicated by block 182 in FIG. 3A. It can also generate different types of charts, such as a bar chart or pie chart, as indicated by block 184. It can generate histograms 186, various different types of diagrams 188, or a wide variety of other data structures 190 that show the summary data calculated by summary calculation component 132.

System 126 then automatically displays the summary data structure or structures to user 106 on the user interface display 102. This is indicated by block 192 in FIG. 3B. Where more than one summary view data structures have been generated (such as a summary view with averages calculated, and a summary view with sums calculated, or where two different structures have been generated, such as a pie chart and a histogram), then summary view generation system 126 can display the suggested summary data structure with one or more user input mechanisms that allow the user to quickly switch between the various summary views that have been calculated. This is indicated by block 194 in FIG. 3B.

In one example, the summary view data structure is also displayed with insertion functionality 196. This allows insertion component 136 to detect a user input on the insertion functionality 196, indicating that user 106 wishes to insert the displayed summary view into the document containing structured data 124. The summary view can be displayed in other ways as well, and this is indicated by block 198.

If insertion component 136 does detect that user 106 has provided an insertion input using the insertion functionality 196, then insertion component 136 inserts and saves the summary data structure based on the user insertion input. This is indicated by block 200 and 202 in FIG. 3B. As one example, the user can drag the displayed summary view to a desired location in the document containing structured data 124. At that point, insertion component 136 inserts the summary view at the location indicated by the user. This is only one example of how a user can provide an insertion input, and the user can do this in a wide variety of different ways.

Before proceeding with a more detailed description of how pattern detector 130 detects user interaction patterns, a number of examples will first be described. FIGS. 3C-3H show a first example in which a user interaction pattern is detected, and a summary view is generated for the user. FIG. 3C shows one illustrative user interface display 210. User interface display 210 shows a spreadsheet in which a set of structured data generally indicated at 212 is presented to the user. The structured data is presented in two columns, a “person” column 214 and an “order” column 216. The person column 214 contains names of people and the order column 216 contains an order indicator that identifies a particular restaurant order that is being placed by the corresponding person. For instance, the first row in structured data 212 indicates that Laurence has ordered beef. The second row indicates that Janice has ordered chicken and so forth.

FIG. 3D shows that user 106 has now provided a user interaction input indicating that the user wishes to sort the order column 216 alphabetically. In one embodiment, the user does this by simply touching the header of order column 216. It can also be seen that sort component 112 (shown in FIG. 1) thus sorts the structured data 212, alphabetically, based upon the values in the order column 216.

FIG. 3E shows that the user has now selected the cells in the order column 216 for which people ordered “lamb”. In the example shown in FIG. 3E, the user interface display device that is being used to display user interface display 210 is a touch sensitive screen. Therefore, the user can select the cells in row 216 for which people ordered “lamb” by touching and sliding along the user interface display surface to encompass those two cells. This is indicated by a selection box 218.

In the example shown in FIG. 3E, it can thus be seen that order column 216 has a set of repeating values. Those values are beef, chicken, lamb and vegetarian. The user has sorted on column 216, and then selected all of the cells in column 216 that contain a similar value (the user has selected all of the “lamb” cells in column 216). Thus, in one example, pattern detector 130 detects this set of user interaction inputs (sorting on a column with repeating values and then selecting all of the cells in that column with the same value) is a pattern for which summary data is to be calculated and presented to the user.

Thus, in one example, pattern detector 130 indicates to summary calculation component 132 that a pattern has been detected, and summary calculation component 132 automatically calculates summary data for structured data 212. Summary data structure generator 134 then generates a summary data structure that can be displayed to user 106. This is shown generally at 220 in FIG. 3E. It can be seen that the summary view 220 represents a picot table where the structured data 212 is summarized by (or pivoted by) the values in the order column 216. Summary calculation component 132 calculated a count for each value in order column 216, along with a grand total value. Thus, summary view 220 shows that the number of people that ordered beef is 3, the number that ordered chicken is 3 and the number that ordered lamb and vegetarian are 2 each. It also shows the grand total of all orders is 10.

Summary view 220 also includes a set of user input mechanisms 222 and 224. These mechanisms indicate that either summary calculation component 132 has generated additional summary views, or summary data structure generator 134 has generated additional data structures for showing the same data as shown in summary view 220, or both. By actuating one of the user input mechanisms 222-224, user 106 can quickly scan through the various summary views that have been generated to identify whether user 106 wishes to insert one of those views into the document containing structured data 212.

FIG. 3E also shows that, in one example, insertion component 136 (shown in FIG. 1) has included an insertion user input mechanism 226 on summary view 220. When the user actuates mechanism 226, the user can easily insert summary view 220 into the spreadsheet shown in user interface display 210. FIG. 3F is a user interface display illustrating this.

FIG. 3F shows, for instance, that the user has actuated mechanism 226. Thus, summary view 220 becomes undocked from the remainder of the spreadsheet so that user 106 can drag summary view 220 to a desired location on the user interface display and insert it there. FIG. 3G shows that, in one example, the other user input mechanisms around summary view 220 can disappear once the user begins dragging summary view 220. FIG. 3H shows that the user has moved summary view 220 to the center of the user interface display and dropped it there. At that point, insertion component 136 automatically inserts summary view 220 into the document (e.g., the spreadsheet) that contains structured data 212.

FIGS. 3I-3L show another example in which pattern detector 130 detects a user interaction pattern for which summary data is to be calculated and displayed. It will be noted that, in the example illustrated in FIGS. 3C-3H, the user sorted on a column that contained repeating values, and then selected all cells in the sorted column that had a common value. In response, pattern detector 130 detected a pattern. The example shown in FIGS. 3I-3L, however, illustrate an example in which the user interacts with data items that do not, themselves, have identical values. Instead, the commonality associated with the data with which the user is interacting is found elsewhere, other than on the data items themselves.

FIG. 3I, for instance, shows a set of structured data 230. Structured data 230 has a person column 232, a project column 234 and an hours column 236. Each row in person column 232 has a person's name. Each row in project column 234 has a project identifier and each row in hours column 236 identifies the number of hours that the identified person has worked on the identified project. FIG. 3I also shows that structured data 230 has repeating values. Column 232, for instance, has repeated names. Column 234 has repeated project identifiers, and column 236 has repeated hour quantities. It will be noted that, as discussed in more detail below, each column need not have repeating values for a pattern to be identified. It is sufficient that one or more columns or rows has repeating values.

FIG. 3J shows that user 106 has sorted structured data 230 by project. That is, in one example, user 106 has provided an input indicating that he or she wishes to have structured data 230 sorted, in alphabetical order, by the project identifiers in project column 234. FIG. 3J shows the result of this sort operation.

FIG. 3K shows that user 106 has now selected four different hour fields in hours column 236. This is represented by selection box 238. It can be seen that the hour values in the selection box 238 are not all the same. It can also be seen that the values in the person column 232 corresponding to the selected hour values 238 are not the same either. However, it can also be seen that the selected hour values 238 all correspond to project A in project column 234. Thus, in one example, pattern detector 130 detects these user interaction inputs as indicating a pattern for which summary data is to be calculated and displayed to the user. FIG. 3K also illustrates that, in one example, an average, a count and a sum are all calculated and displayed at 240.

Summary calculation component 132 thus calculates a set of summary data based on structured data 230. For instance, it can calculate the total number (the sum) of hours per project, the average number of hours per person, per project, etc. For each of these sets of summary data, summary data structure generator 134 generates a data structure that will present the summary view of the data to user 106. Thus, summary data structure generator 134 can generate a pivot table, a pie chart, or a variety of other summary views.

FIG. 3L shows one example in which summary data structure generator 134 has generated a pivot table 242 that shows a summary view of structured data 230. In the example shown in FIG. 3L, table 242 shows the sum of hours worked on each different project in structured data 230. It also shows a total number of hours worked on all three projects. As with the example discussed above in FIGS. 3C-3H, insertion component 136 can also display an insertion user input mechanism 244 that user 106 can use to quickly insert summary view 242 into the document containing structured data 230.

FIG. 4 is a flow diagram illustrating one example of how pattern detector 130 can detect patterns for which summary data is to be generated. FIG. 4 assumes that some type of structured data is being displayed or otherwise presented to the user. Pattern detector 130 then receives a user interaction input interacting either with the displayed data items themselves, or with the data structure that is being used to display the data items. This is indicated by block 250 in FIG. 4. As illustrated in the above examples, the user can interact with the data items themselves, such as by selecting cells where the data items reside. The user can also interact with the data structure, instead of the data items themselves, such as by providing a sort input indicating that the user wishes to sort the structured data.

Once the user interaction input is received, then pattern detector 130 first detects whether the structured data has some types of repeating or common values. This is indicated by block 252. If there are no repeating or common values in the structured data, then no summary view is calculated or suggested to the user. This is indicated by block 254.

However, if the structured data does have some types of repeating values (or commonality), then pattern detector 130 determines whether the user is somehow interacting with data items that have some (even partial) commonality. This is indicated by block 256 in FIG. 4. Again, if the user is not interacting in any way with any types of data items that have even partial commonality, then no summary view is calculated or suggested, as indicated by block 254. However, if there is some commonality, then a pattern can be detected.

Before continuing with the description of FIG. 4, FIG. 5 is a block diagram illustrating some different examples of the types of commonality 258 that can exist in the structured data, and for which a pattern can be identified. For instance, the user may be interacting with a data item that has the same value as another data item in the structured data. This is indicated by block 260. In addition, the values of the interacted data item may match exactly as indicated by block 262. By way of the example shown in FIGS. 3C-3H, the user interacted with the data items 218 that have the exact same value “lamb”.

However, the data items may only have a partially matched value, as indicated by block 264. By way of example, assume that the field that the user is interacting with in the structured data is a date field that includes a month value, a day value and a year value. It may be that the user has selected a set of cells where the year value is the same, but the month and day values are not the same. In that example, pattern detector 130 can still detect this as partial commonality in the data items that the user is interacting with, and identify a pattern.

In another example, assume that the user is interacting with cells in a “name” column Assume that the user has selected a plurality of different cells, all of which have a name beginning with the same first letter. In such an example, even though the entire name field for the selected cells does not have the same value, pattern detector 130 can detect that the names all begin with the same letter. This type of partial commonality may be sufficient to identify a pattern.

Further, partial commonality may be indicated where the data items themselves do not have the same values, but some corresponding data item (such as another entry in the same row as the selected data item) have commonality. This is indicated, for instance, in the example discussed above with respect to FIGS. 3I-3L. It can be seen that while the user selected cells 238 in the hours column, the value in those cells is not common. However, other corresponding cells (the cells in the project column and corresponding to the selected hours 238) did have a common value. Thus, pattern detector 130 can detect commonality in associated or corresponding cells, and not the cells being interacted with, themselves.

It will be noted that the commonality can be identified as common numeric values 266 or common textual values 268. However, the commonality may be detected in other ways as well. For instance, when data items are selected with a common format 270, this may give rise to a detected pattern. By way of example, in a business system, key performance indicators may be displayed in a structure and identified in a visually distinguishing way (such as shaded in red) to indicate that they are outside of an expected range. If the user begins selecting all data items that are shaded in red, then pattern detector 130 can detect that the commonality is in the format, instead of the value itself. Similarly, commonality in format can be based not only on color, but on shading, font size, font style (bold, italics, etc.) or in other ways.

In another example, pattern detector 130 detects commonality based on the edit history of the selected data items. This is indicated by block 272. For instance, if a user is selecting only data items that have been recently changed, then pattern detector 130 can detect this as a pattern.

Pattern detector 130 can also detect patterns where the values are not the same, but instead the count of the values or some other characteristic (such as whether the values are sequential) is common. By way of example, it may be that user 106 is viewing business invoice data, and the user first selects all invoices numbered 100-199. It may then be that user 106 begins selecting invoices in a different sequential range, such as invoices in a range of 200-299. Pattern detector 130 can identify this as a pattern (e.g., that the user is selecting sequential invoices in batches of 100) and can calculate summary data on that basis as well. This is indicated by block 274 in FIG. 5. Pattern detector 130 can, of course, detect patterns in a wide variety of other ways as well. This is indicated by block 276.

Returning again to FIG. 4, assuming that at block 256 that the user is interacting (either directly or indirectly by interacting with the structure) with data items that have some type of commonality, then pattern detector 130 can identify the type of user interaction being performed. For instance, instead of actually selecting data items, it may be that user 106 is simply using a cursor to guide his or her eyes over data items with commonality. As an example, assume the user is manually adding numeric values in cells that have some type of commonality and, in doing so, the user is using the cursor to guide his or her eyes to those cells. In that case, the user may simply be hovering the cursor over different data items, instead of actually selecting them. Hovering over data items with commonality is indicated by block 280 in FIG. 4.

As discussed above, the user may actually be selecting data items. It will be noted, however, that the user need not be selecting individual cells or individual data items. The user may be selecting rows, columns, or other data items that have commonality as well. This is indicated by block 282.

Pattern detector 130 can also detect a pattern using a set of different types of user interaction inputs. For instance, as discussed above with the examples in FIGS. 3C-3L, user 106 may first provide a sort input 284 and then provide a set of selection inputs, from the sorted data, on data items that have a common attribute. This is indicated by block 286.

It will be appreciated that pattern detector 130 can detect other types of user interaction inputs as well. This is indicated by block 288.

It will be noted that the type of user interaction inputs may be detected in different ways, depending upon the different type of device that the user is using. For instance, where the user is using a device with a touch-sensitive screen, the interaction inputs can be detected based on touch gestures (such as touch, touch and slide, swipe, etc.). Where the user is using a desktop device, the interaction inputs may be inputs from a keyboard or point and click device, etc.

Once pattern detector 130 has detected not only the data items being interacted with (and that they have some type of commonality), but also the kind of interaction, then pattern detector 130 illustratively identifies a pattern for which a summary view can be calculated and suggested. This is indicated by block 290 in FIG. 4. Pattern detector 130 then indicates this to summary calculation component 132 so that component 132 can calculate the desired summary views of the data.

The summary views can be displayed in different ways based upon the device. On a desktop or laptop (e.g., on a device with a relatively large amount of display real estate) the summary view may be initially generated to the side of the structured data that the user is viewing. When the user is viewing structured data on a limited display real estate device (such as a smart phone, a tablet computer, etc.) then the summary view may be generated across a substantial portion of the display device, and even over some or all of the structured data that the user is viewing. Of course, these are examples only and a wide variety of different display techniques can be used.

This allows a user to quickly surface patterns or other summary results that may have otherwise gone unnoticed. It provides summary data the user may not otherwise generate. It also enables the user to more easily take advantage of certain functionality in the application.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands. Further, the interface “displays” can include, or comprise, audio, haptic or other outputs. The input mechanism can sense haptic, or movement-based inputs (such as shaking a mobile phone, rotating it, etc.).

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

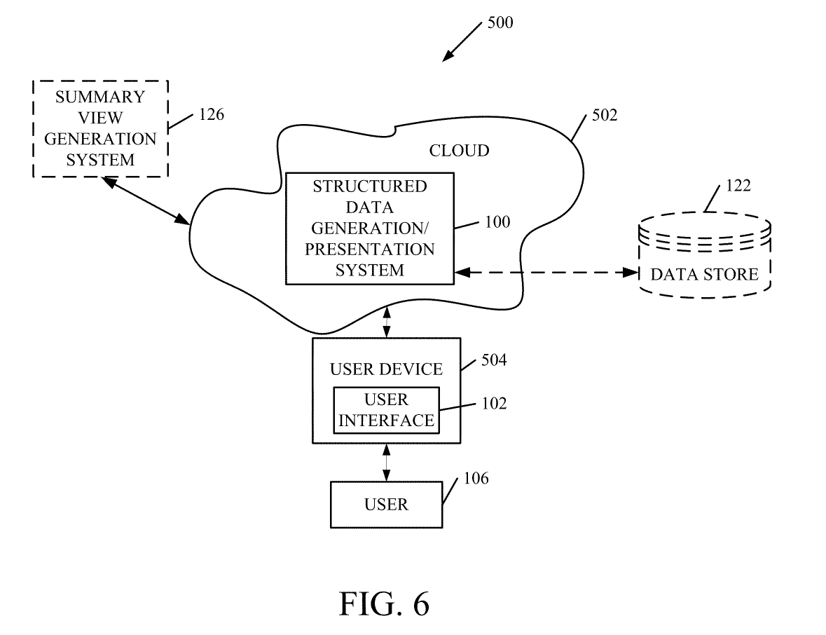

FIG. 6 is a block diagram of system 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 6, some items are similar to those shown in FIG. 1 and they are similarly numbered. FIG. 6 specifically shows that structured data generation/presentation system 100 can be located in cloud 502 (which can be public, private, or a combination where portions are public while others are private). Therefore, user 106 uses a user device 504 to access those systems through cloud 502.

FIG. 6 also depicts another embodiment of a cloud architecture. FIG. 6 shows that it is also contemplated that some elements of system 100 can be disposed in cloud 502 while others are not. By way of example, data store 122 can be disposed outside of cloud 502, and accessed through cloud 502. In another embodiment, summary view generation system 126 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include local or remote servers, desktop computers, laptop computers, tablet computers, or other mobile devices, such as palm top computers, cell phones, smart phones, multimedia players, personal digital assistants, etc.

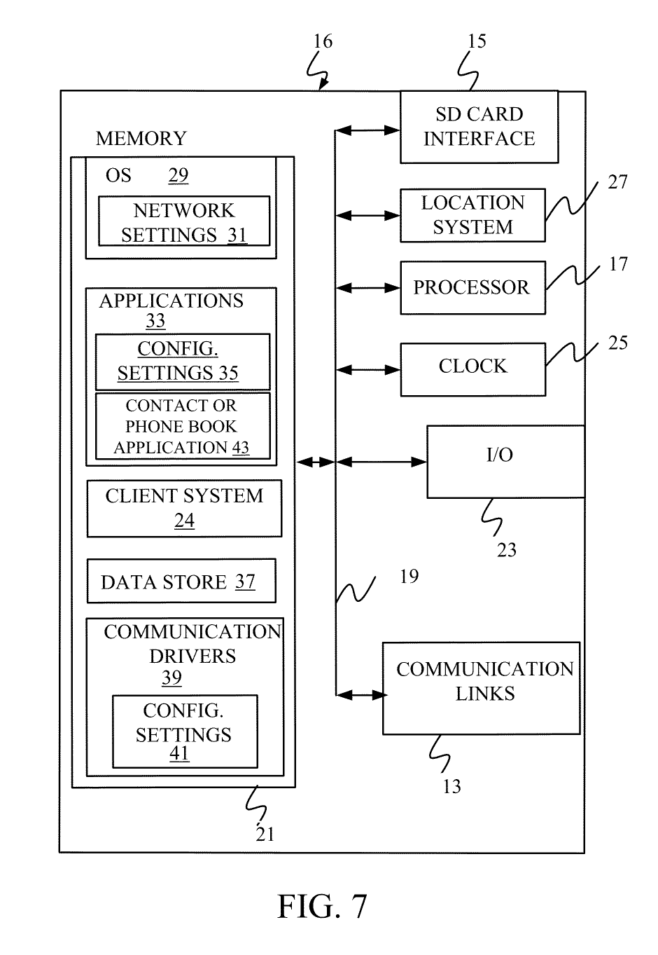

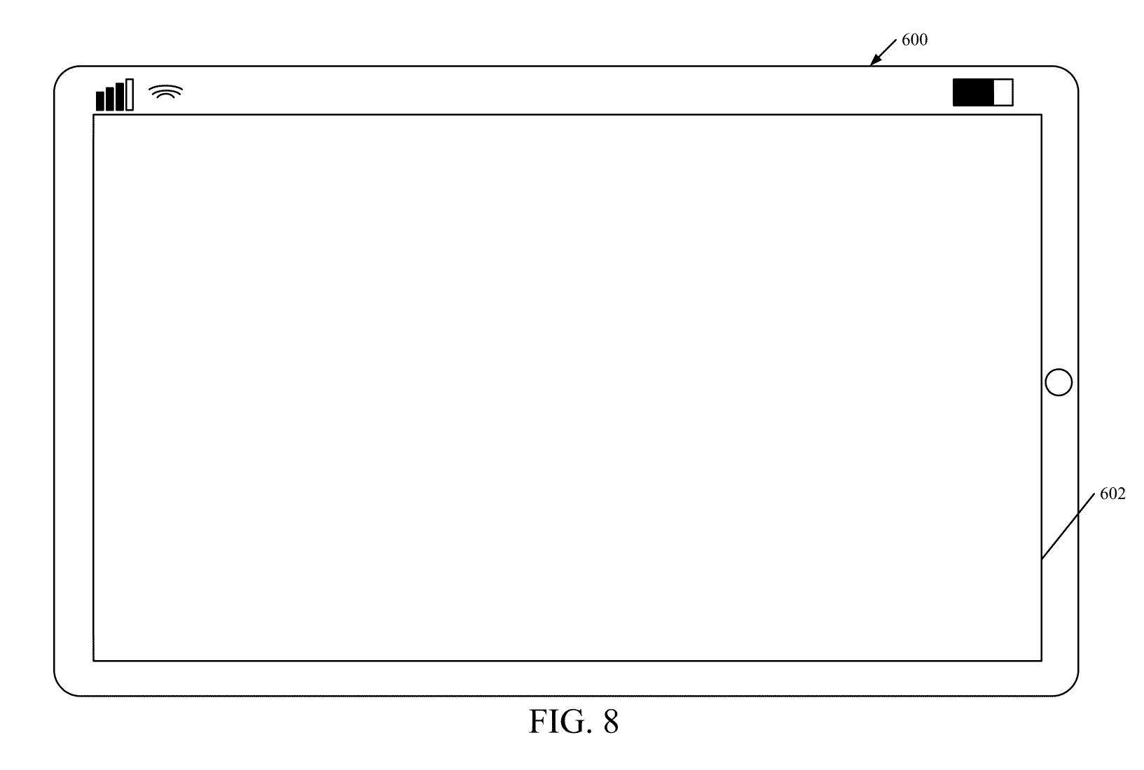

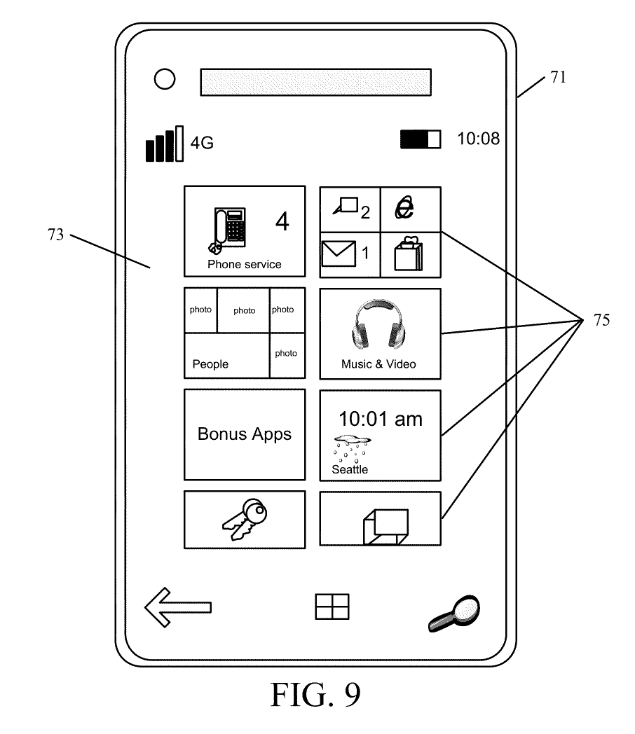

FIG. 7 is a simplified block diagram of one illustrative embodiment of a handheld or mobile computing device that can be used as a user's or client's hand held device 16, in which the present system (or parts of it) can be deployed. FIGS. 8-9 are examples of handheld or mobile devices.

FIG. 7 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks. It can also use a wide variety of different near field communication mechanisms.

Under other embodiments, applications or systems are received on a removable Secure Digital (SD) card that is connected to a SD card interface 15. SD card interface 15 and communication links 13 communicate with a processor 17 (which can also embody processor 108 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one embodiment in which device 16 is a tablet computer 600. In FIG. 8, computer 600 is shown with user interface display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. For instance, device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some embodiments, the phone also includes a Secure Digital (SD) card slot that accepts a SD card.

The mobile device 16 can also be a personal digital assistant (PDA) or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 9 shows one embodiment of a smart phone 71 which can comprise mobile device 16. Smart phone 71 has a touch sensitive display 73 that displays icons or tiles or other user input mechanisms 75. Mechanisms 75 can be used by a user to run applications, (such as system 100), make calls, perform data transfer operations, etc. In general, smart phone 71 is built on a mobile operating system and offers more advanced computing capability and connectivity than a feature phone.

Note that other forms of the devices 16 are possible.

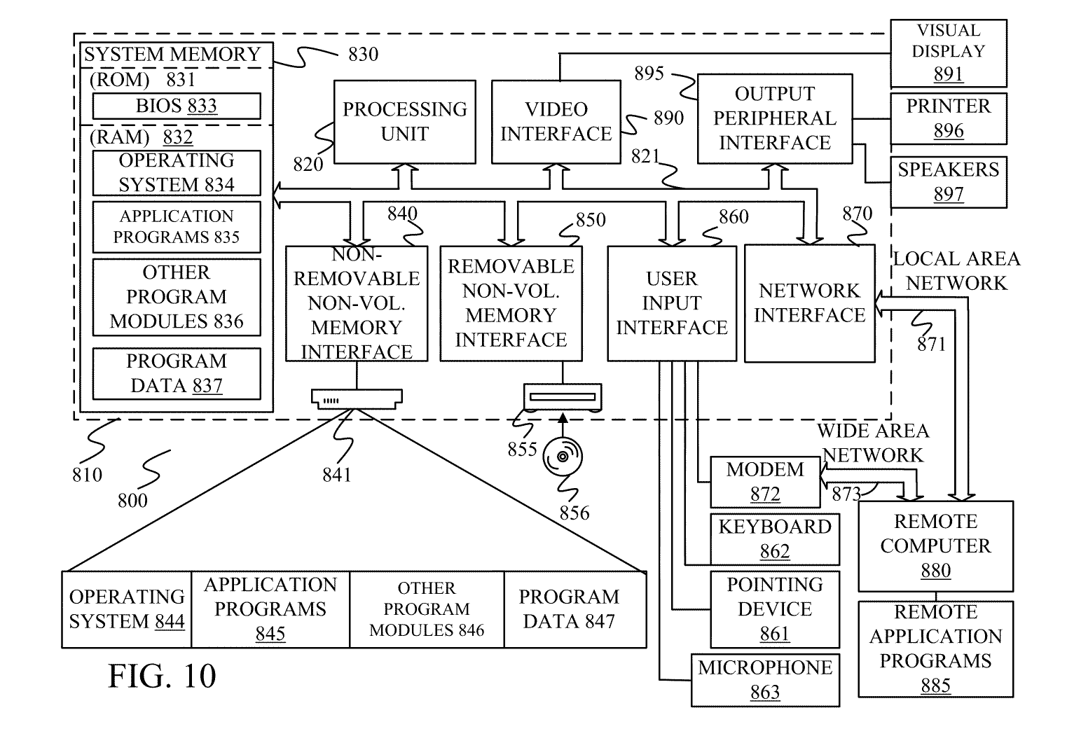

FIG. 10 is one embodiment of a computing environment in which system 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 108), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 is typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

In a first example, a computer-implemented method, comprises:

displaying data, from a document, in a structure on a user interface display;

identifying that the data comprises data items with commonality;

receiving a set of user interactions with the user interface display;

detecting that the user interactions are indicative of a pattern;

automatically displaying a summary data view showing summary data calculated based on the data and based on the detected pattern; and

automatically displaying an insertion user input mechanism that is actuated to insert the summary view into the document.

In a second example, the computer-implemented method of example 1, and further comprising:

receiving user actuation of the insertion user input mechanism; and

automatically inserting the summary view into the document in response to the user actuation of the insertion user input mechanism.

Example 3 is the computer-implemented method of any or all previous examples wherein receiving the set of user interactions comprises:

receiving the set of user interactions with the structure.

Example 4 is the method of any or all previous examples wherein receiving the set of user interactions comprises:

receiving the set of user interactions with one or more of the data items.

Example 5 is the computer-implemented method of any or all previous examples wherein detecting a pattern comprises:

identifying that the set of user interactions comprise interactions with the data items that have commonality.

Example 6 is the computer-implemented method of any or all previous examples wherein identifying that the set of user interactions comprise interactions with the data items that have commonality, comprises:

identifying that the set of user interactions comprise hovering a cursor over the data items that have commonality.

Example 7 is the computer-implemented method of any or all previous examples wherein identifying that the set of user interactions comprise interactions with the data items that have commonality, comprises:

identifying that the set of user interactions comprise selecting data items that have commonality.

Example 8 is the computer-implemented method of any or all previous examples wherein displaying data in a structure comprises displaying the data as data items in rows and columns, and wherein identifying that the set of user interactions comprise selecting data items that have commonality comprises:

identifying that the set of user interactions comprise selecting data items in rows or columns that have commonality with other rows or columns, respectively.

Example 9 is the computer-implemented method of any or all previous examples wherein displaying data in a structure comprises displaying the data as data items in rows and columns, and wherein identifying that the set of user interactions comprise selecting data items that have commonality comprises:

identifying a sort user input sorting on a row or a column to obtain sorted data; and

identifying user selection of a range of data items, that have a common attribute, from the sorted data.

Example 10 is the computer-implemented method of any or all previous examples and further comprising:

generating a plurality of different summary views; and

displaying a user selection mechanism for selection of one of the plurality of different summary views.

Example 11 is the computer-implemented method of any or all previous examples wherein automatically displaying a summary view comprises:

automatically displaying a pivot table for the data items.

Example 12 is a computer system, comprising:

a user interface system that displays data in a structure on a user interface display;

a pattern detector that detects that user interactions with the user interface display are indicative of a pattern;

a summary calculation component that, in response to the pattern detector detecting that the user interactions are indicative of a pattern, automatically calculates summary data based on the data, the user interface system displaying a summary view indicative of the summary data; and

a computer processor that is a functional part of the computer system and is activated by the user interface system, the pattern detector and the summary calculation component to facilitate displaying, detecting and calculating.

Example 13 is the computer system of any or all previous examples and further comprising:

a summary data structure generator that automatically generates a summary data structure to display the summary data in the summary view.

Example 14 is the computer system of any or all previous examples wherein the summary data structure generator automatically generates the summary data structure as a pivot table.

Example 15 is the computer system of any or all previous examples wherein the summary data structure generator automatically generates the summary data structure as a chart.

Example 16 is the computer system of any or all previous examples wherein the summary data structure generator automatically generates the summary data structure as a graph.

Example 17 is the computer system of any or all previous examples wherein the pattern detector detects that user interactions with the user interface display are indicative of a pattern by detecting that the user interactions are interacting with data items, that have at least partial commonality, in the structure.

Example 18 is the computer system of any or all previous examples wherein the pattern detector detects that user interactions with the user interface display are indicative of a pattern by detecting that the user interactions are interacting with data items that have repeating values in the structure.

Example 19 is a computer readable storage medium that stores computer executable instructions which, when executed by a computer, cause the computer to perform a method, comprising:

displaying data in a structure on a user interface display;

receiving a set of user interactions with the user interface display;

detecting a pattern indicated by the user interactions being with data items that have commonality; and

automatically displaying a summary data view showing summary data calculated based on the data and based on the detected pattern.

Example 20 is the computer readable storage medium of any or all previous examples wherein displaying data in a structure comprises displaying the data as data items in rows and columns, and wherein detecting a pattern comprises:

identifying a sort user input sorting on a row or a column to obtain sorted data; and

identifying user selection of a range of data items, that have a common attribute, from the sorted data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
displaying data, from a document, in a structure on a user interface display;
identifying that the data comprises data items with commonality;
receiving a set of user interactions with the user interface display;
detecting that the user interactions are indicative of a pattern;
automatically displaying a summary data view showing summary data calculated based on the data and based on the detected pattern; and
automatically displaying an insertion user input mechanism that is actuated to insert the summary view into the document.

2. The computer-implemented method of claim 1, and further comprising:
receiving user actuation of the insertion user input mechanism; and
automatically inserting the summary view into the document in response to the user actuation of the insertion user input mechanism.

3. The computer-implemented method of claim 1 wherein receiving the set of user interactions comprises:
receiving the set of user interactions with the structure.

4. The computer-implemented method of claim 1 wherein receiving the set of user interactions comprises:
receiving the set of user interactions with one or more of the data items.

5. The computer-implemented method of claim 1 wherein detecting a pattern comprises:
identifying that the set of user interactions comprise interactions with the data items that have commonality.

6. The computer-implemented method of claim 5 wherein identifying that the set of user interactions comprise interactions with the data items that have commonality, comprises:
identifying that the set of user interactions comprise hovering a cursor over the data items that have commonality.

7. The computer-implemented method of claim 5 wherein identifying that the set of user interactions comprise interactions with the data items that have commonality, comprises:
identifying that the set of user interactions comprise selecting data items that have commonality.

8. The computer-implemented method of claim 5 wherein displaying data in a structure comprises displaying the data as data items in rows and columns, and wherein identifying that the set of user interactions comprise selecting data items that have commonality comprises:
identifying that the set of user interactions comprise selecting data items in rows or columns that have commonality with other rows or columns, respectively.

9. The computer-implemented method of claim 5 wherein displaying data in a structure comprises displaying the data as data items in rows and columns, and wherein identifying that the set of user interactions comprise selecting data items that have commonality comprises:
identifying a sort user input sorting on a row or a column to obtain sorted data; and
identifying user selection of a range of data items, that have a common attribute, from the sorted data.

10. The computer-implemented method of claim 1 and further comprising:
generating a plurality of different summary views; and
displaying a user selection mechanism for selection of one of the plurality of different summary views.

11. The computer-implemented method of claim 1 wherein automatically displaying a summary view comprises:
automatically displaying a pivot table for the data items.

12. A computer system, comprising:
a user interface system that displays data in a structure on a user interface display;
a pattern detector that detects that user interactions with the user interface display are indicative of a pattern;
a summary calculation component that, in response to the pattern detector detecting that the user interactions are indicative of a pattern, automatically calculates summary data based on the data, the user interface system displaying a summary view indicative of the summary data; and
a computer processor that is a functional part of the computer system and is activated by the user interface system, the pattern detector and the summary calculation component to facilitate displaying, detecting and calculating.

13. The computer system of claim 12 and further comprising:
a summary data structure generator that automatically generates a summary data structure to display the summary data in the summary view.

14. The computer system of claim 13 wherein the summary data structure generator automatically generates the summary data structure as a pivot table.

15. The computer system of claim 13 wherein the summary data structure generator automatically generates the summary data structure as a chart.

16. The computer system of claim 13 wherein the summary data structure generator automatically generates the summary data structure as a graph.

17. The computer system of claim 12 wherein the pattern detector detects that user interactions with the user interface display are indicative of a pattern by detecting that the user interactions are interacting with data items, that have at least partial commonality, in the structure.

18. The computer system of claim 12 wherein the pattern detector detects that user interactions with the user interface display are indicative of a pattern by detecting that the user interactions are interacting with data items that have repeating values in the structure.

19. A computer readable storage medium that stores computer executable instructions which, when executed by a computer, cause the computer to perform a method, comprising:
displaying data in a structure on a user interface display;
receiving a set of user interactions with the user interface display;
detecting a pattern indicated by the user interactions being with data items that have commonality; and
automatically displaying a summary data view showing summary data calculated based on the data and based on the detected pattern.

20. The computer readable storage medium of claim 19 wherein displaying data in a structure comprises displaying the data as data items in rows and columns, and wherein detecting a pattern comprises:
identifying a sort user input sorting on a row or a column to obtain sorted data; and
identifying user selection of a range of data items, that have a common attribute, from the sorted data.
